(19) United States
(12) Patent Application Publication
(10) Pub. No.: US 2008/0152159 A1
(43) Pub. Date: Jun. 26, 2008

(54) Method for influencing sound

(76) Inventor: Uwe Kassner, Moeglingen (DE)

Correspondence Address: KENYON & KENYON LLP, ONE BROADWAY, NEW YORK, NY, 10004, US

(21) Appl. No.: 12/001,718

(22) Filed: Dec. 11, 2007

(30) Foreign Application Priority Data
Dec. 15, 2006 (DE) 102006059351.0

(51) Int. Cl. G10K 11/16

(52) U.S. Cl. 381/71.5

(57) ABSTRACT

A method for influencing sound in an aggregate in the periphery of an internal combustion engine of a vehicle, particularly in an exhaust system of the internal combustion engine, a sound-influencing signal being generated on the basis of a detected sound emission of the aggregate and being injected into the aggregate, in which additionally, the sound-influencing signal is generated as a function of a parameter that is independent of the operating point of the internal combustion engine.

### FIELD OF THE INVENTION

The present invention relates to a method for influencing sound in an aggregate in the periphery of an internal combustion engine of a vehicle, particularly in an exhaust system of the internal combustion engine, a sound-influencing signal being generated on the basis of a detected sound emission of the aggregate and being injected into the aggregate. The present invention also relates to a sound-influencing device for implementing such a method and a computer program having program code for executing all steps of such a method.

### BACKGROUND INFORMATION

From the related art, it is known to influence unwanted sound signals by an active noise influence using a suitable compensating sound field. To that end, in a control loop, as a function of a sound signal picked up by a microphone, a sound-influencing signal is generated that, in turn, is injected via a sound transducer into the muffler of the exhaust system. The control loop includes a controller having parameters that are stored as a function of the operating point. The controller is adapted as a function, for example, of the engine speed, the engine load and the ignition angle, that is, variables which are a function of the operating point, in order to achieve a specific control objective, e.g., minimal noise generation at the exhaust system. For the explanation of a corresponding device, reference is also made to the publication “Variable Gestaltung des Abgasmündungsgerauschs am Beispiel eines V6-Motors” (Variable Formation of the Exhaust-Gas Outlet Noise, Using a V6 Engine As an Example), Heil, Enderle, MTZ 10/2001, Pages 786-794. Moreover, it is known from the related art that the controller is able to implement various control objectives, for example, minimal noise or an acoustic design control objective with intentional influencing of the noise character.

A disadvantage in the related art is that the adjustment of the sound generation permits only a very limited adaptation to environmental conditions, driving situations and preferences of the driver.

### SUMMARY OF THE INVENTION

An object of the present invention is to permit a more comprehensive influencing of the sound emission output by an aggregate in the periphery of an internal combustion engine of a vehicle; in particular, response to preferences of the driver, environmental conditions or other boundary conditions should be possible. In general, it is an object of the present invention to improve methods and devices which are known from the related art.

This objective is achieved by a method for influencing sound in an aggregate in the periphery of an internal combustion engine of a vehicle, particularly in an exhaust system of the internal combustion engine, a sound-influencing signal being generated on the basis of a detected sound emission of the aggregate and being injected into the aggregate, in which additionally, the sound-influencing signal is generated as a function of a parameter which is independent of the operating point of the internal combustion engine. The aggregate of the internal combustion engine may be the exhaust system of the internal combustion engine or the air intake tract of the internal combustion engine. Preferably, the sound-influencing signal is generated by a controller and fed to a sound transducer, e.g., a solenoid-coil loudspeaker or a piezoelectric loudspeaker, and injected into the aggregate. The sound transducer converts the electric sound-influencing signal into an acoustic signal. Preferably, the controller is connected on the incoming side to a microphone that makes it possible to pick up the sound emission of the aggregate, the microphone preferably being disposed near the aggregate. According to the present invention, the sound-influencing signal is additionally generated as a function of a parameter that is independent of the operating point of the internal combustion engine. Examples for parameters that are independent of the operating point of the internal combustion engine are external variables that do not describe the operating point of the engine, i.e., both parameters internal to the vehicle and parameters external of the vehicle.

In general, the present invention offers the advantage that a better accommodation of the noise generation of the aggregate in the periphery of the internal combustion engine to various ambient, environmental or vehicle conditions is possible, so that the noise characteristics may be better adapted to preferences of the driver or statutory regulations.

Preferably, two control objectives are stored for generating the sound-influencing signal, one of the control objectives or an average value of the control objectives being used for generating the sound-influencing signal as a function of the parameter. For example, the at least two control objectives may include the control objectives of minimal noise and generation of a desired noise characteristic, the necessary settings of digital filters or of the controller being switched over accordingly. A phased transition between the different control objectives offers special advantages. In general, the control objectives offer the advantage that it is possible to adapt the noise generation of the aggregate to various factors; because of a phased transition, the driver barely notices the influencing of the sound, since no abrupt transition takes place.

Advantageously, the parameter describes the behavior of a driver of the vehicle. The behavior of the driver may describe aspects of the driving style of the driver. This offers the advantage that a sporty driver gets to hear a background noise of the vehicle supposedly more pleasing to him. Vice versa, upon recognition of a reserved driving style of the driver, this offers the possibility to change over to a control objective of minimal noise, so that the reserved driver in the vehicle will feel at ease. Preferably a parameter already existing in the vehicle is used, e.g., a transmission parameter which adapts the shifting characteristics of an automatic transmission of the vehicle to the behavior of the driver.

Advantageously, the driver behavior described by the parameter is the manner of operating the accelerator of the vehicle, the gear selection specific to the vehicle speed or a selected cornering speed of the vehicle. This has the advantage that the background noise generated by the aggregate is matched to the driving style of the driver. One preferred possibility is to infer the behavior of the driver from the manner in which the accelerator is operated; thus, in the case of an accelerator depressed frequently with a large gradient, that is with great speed, with high absolute values, a sporty driving style may be inferred. This recognition is to be differentiated from the parameters of the internal combustion engine as a function of the operating point, which, for example, relate to a throttle position or an ignition angle as a function of the absolute accelerator position. Thus, the present invention provides that the parameter independent of the operating point of the internal combustion engine is preferably adapted over a longer period of time. In addition, this has the advantage that no rapid changes occur in the sound characteristics of the aggregate.

In one advantageous specific embodiment of the present invention, the parameter is stored specific to the driver, and upon recognition of the driver by the vehicle, is used in the generating of the sound-influencing signal. This offers the advantage that the sound of the aggregate most pleasing to each driver can be generated for that driver. It is advantageous if the driver is recognized via an individual key or electronic key. Such a driver recognition is already known from the related art and is used, for example, to automatically adjust the position of the driver's seat. A further preferred possibility is to provide the driver with the opportunity to select the sound characteristics, i.e., the parameter, according to his/her preferences, e.g., via an existing on-board computer.

Preferably, the parameter includes information about the geographical location of the vehicle or about the time, so that the sound-influencing signal is generated as a function of the geographical location of the vehicle or the time. The information about the geographical location of the vehicle or about the time may be information available in the vehicle in any case, for example, from a GPS system. Special advantages are yielded if this information is compared to known data about the geographical area of regions protected from noise, or with data relating to noise-protection stipulations as to time. In general, therefore, the advantageous possibility is provided to adapt the sound characteristics to the surroundings or to noise-protection regulations in force; thus, within built-up communities or areas having special noise-protection requirements, it is possible to switch the controller to the control objective “minimal noise.” Thus, this control objective may be selected nights in response to higher noise-protection requirements.

Advantageously, the parameter includes information about the setting of one component of the vehicle, so that the sound-influencing signal is generated as a function of the setting of the component. The component may be the suspension of the vehicle, so that in the case of a harder suspension setup, the control objective “acoustic design” is put into effect by the controller when generating the sound-influencing signal, and not the control objective “minimal noise.” This offers the advantage that the background noise is automatically adapted to other adjustments and settings of the vehicle.

The further component is preferably a variable convertible top of the vehicle. This provides the advantage that when the convertible top is open, it is possible to switch to the control objective “acoustic design.”

A further subject matter of the present invention is a sound-influencing device which is set up to implement a method according to the present invention, possibly having one or more of the advantageous features indicated above.

A computer program is likewise a subject matter of the present invention, which includes program code for implementing all steps according to one of the advantageous methods presented above when the program is executed in a computer.

### BRIEF DESCRIPTION OF THE DRAWINGS

FIG. 1 shows a sound-influencing device according to the present invention.

FIG. 2 shows a method according to the present invention that is able to be implemented using the sound-influencing device of FIG. 1.

### DETAILED DESCRIPTION

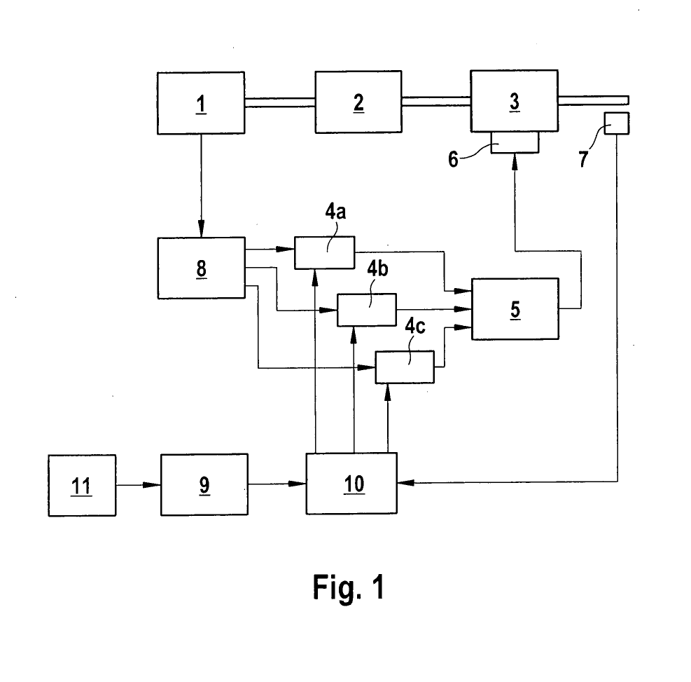

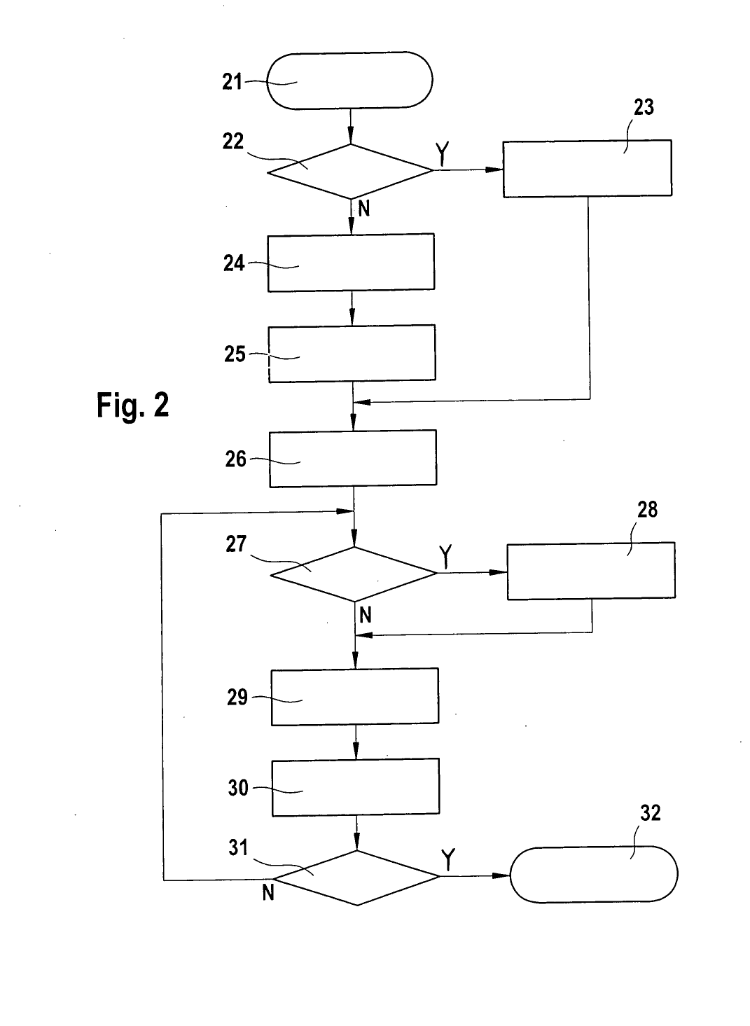

In FIG. 1, an internal combustion engine 1 of a vehicle is connected to a central muffler 2, which is followed by a rear muffler 3. The sound-influencing device includes three controllable digital filters 4a, 4b and 4c, which are tuned to the fundamental frequency and two harmonics (integral multiples of the fundamental frequency). The signals from the digital filters are joined and amplified in a power amplifier 5, in order to drive a sound transducer, more precisely, a loudspeaker 6 with the sound-influencing signal thus generated. Loudspeaker 6 is mounted at rear muffler 3, and thus influences the noise leaving rear muffler 3. This noise is picked up by a microphone 7 which is installed at the outlet of the exhaust system made up of central muffler 2 and rear muffler 3. The signal-influencing device further includes a signal generator 8, which generates the fundamental frequency from the engine speed of internal combustion engine 1. The fundamental frequency is supplied to digital filters 4a, 4b and 4c, so that these digital filters 4a, 4b and 4c are each matched to the engine speed and therefore to the exhaust-gas pulsation. In addition, signal generator 8 is connected to the crankshaft sensor as synchronization source. The sound-influencing device also includes a setpoint adjuster 9 which specifies setpoint values for an adaptation unit 10. Setpoint adjuster 9 specifies the setpoint values as a function of parameters which are independent of the operating point of the internal combustion engine. These parameters are supplied to setpoint adjuster 9 via various parameter inputs. This is described more precisely in detail in connection with FIG. 2.

Adaptation unit 10 is also connected to microphone 7 and digital filters 4a, 4b and 4c. Adaptation unit 10 corrects (tracks) digital filters 4a, 4b and 4c in such a way that the signal, which reproduces the detected sound emission and is picked up by microphone 7 and supplied to adaptation unit 10, corresponds to, or at least essentially corresponds to the setpoint value predefined by setpoint adjuster 9. To that end, adaptation unit 10 changes the filter parameters of digital filters 4a, 4b and 4c. Adaptation unit 10 may also be understood as a controller which corrects digital filters 4a, 4b and 4c in such a way that the deviation between the signal of the sound emission from microphone 7, and predefined setpoint value 9 becomes minimal for each of the frequencies. For that purpose, the adaptation unit uses an adaptation algorithm having a square performance index. In the exemplary embodiment shown, the sound-influencing device is disposed at central muffler 2 and rear muffler 3 which form an aggregate in the periphery of internal combustion engine 1, namely, the exhaust system of internal combustion engine 1. However, the present invention may also be applied to other aggregates in the periphery of the internal combustion engine like, for example, the air-feed system of internal combustion engine 1. The parameters for setpoint adjuster 9 are generated by a central on-board computer 11 of the vehicle, which processes and holds driver-specific information, geographical information, time-related information and vehicle-specific information in readiness.

FIG. 2 shows a flow chart of a method according to the present invention which can be implemented using the sound-influencing device from FIG. 1. In the course of describing the diagram in FIG. 2, reference is made to FIG. 1 and the reference numerals used there.

The method for influencing sound of FIG. 2 begins with a step 21 upon starting internal combustion engine 1. It is subsequently checked whether the driver of the vehicle is already known and whether information about a preferred background noise of the driver is stored. This takes place in a step 22. For example, such information may be obtained from an electronic key used upon opening the vehicle. If the driver is known and information about this driver is stored, then step 22 is followed by a step 23 in which the parameters are stipulated according to the stored preferred background noise of the known driver. On the other hand, if the driver is not known, then following step 22, in an analysis step 24, the behavior of the driver when driving the vehicle is analyzed. Thus, in particular the manner in which the driver operates the accelerator of the vehicle, the gear selected by the driver specific to the vehicle speed (in the case of a manually shifted transmission) and a cornering speed of the vehicle selected by the driver are evaluated in order to ascertain whether the driver more likely prefers a sporty or a reserved driving style. Such an analysis is known from the related art in connection with the specification of parameters for an automatic transmission, and is not explained in greater detail. Following step 24, in a step 25 the parameters to be used for influencing the sound are established. The subsequent steps of the method are in turn also carried out following step 23. In step 26, which follows step 25 and step 23, the setting of one component, here, for example, the setting of a variable convertible top of the vehicle is also checked. During operation with the convertible top open, the parameter for influencing sound is adapted to the effect that the signal output by rear muffler 3 is optimized for driving with the convertible top open.

Subsequently in a step 27, it is checked whether the geographical position of the vehicle or the time, or a combination of these two items of information requires an especially low generation of noise by the vehicle, for example, because the vehicle is being operated in an urban area or during rest periods at night. If this is the case, then in a step 28, the parameter for influencing sound is changed to the effect that the noise emitted by the vehicle is minimized. This is carried out regardless of the information about the behavior of the driver or the setting of one component of the vehicle checked previously, in order to ensure that there is absolute compliance with requirements concerning noise protection. Subsequent to step 27 if no special requirements must be observed concerning noise protection, or subsequent to step 28 in the case of noise-protection requirements, the parameter for setting the background noise of the vehicle is transferred to setpoint adjuster 9. The method steps up to this point were executed by on-board computer 11. Finally, in step 30, setpoint adjuster 9 drives adaptation unit 10 of the sound-influencing device of FIG. 1 in accordance with the parameter ascertained. The method subsequently jumps to a step 31, in which it is checked whether, in the meantime, the internal combustion engine was switched off. If this is the case, the method terminates in a step 32. However, if the internal combustion engine was not yet switched off, the method jumps back to step 27, and the geographical position of the vehicle and the time are then reviewed again, in order to check whether in the meantime, noise-protection values must be observed.

Various control objectives are stored in adaptation unit 10, minimal noise and acoustic design among others; a selection is made from these control objectives based on the setpoint value predetermined by setpoint adjuster 9. In this context, not only the selection of the individual control objectives, but also an interpolation of these control objectives is possible.

What is claimed is:

1. A method for influencing sound in an aggregate in a periphery of an internal combustion engine of a vehicle, comprising:
generating a sound-influencing signal as a function of a detected sound emission of the aggregate and a parameter that is independent of an operating point of the internal combustion engine; and
injecting the sound-influencing signal into the aggregate.

2. The method according to claim 1, wherein the sound is influenced in an exhaust system of the engine.

3. The method according to claim 1, further comprising storing two control objectives for generating the sound-influencing signal, one of the control objectives or an average value of the control objectives being used for generating the sound-influencing signal as a function of the parameter.

4. The method according to claim 1, wherein the parameter describes a behavior of a driver of the vehicle.

5. The method according to claim 4, wherein the driver behavior described by the parameter is at least one of a manner of operating an accelerator of the vehicle, a gear selected specific to a vehicle speed and a selected cornering speed of the vehicle.

6. The method according to claim 1, further comprising storing the parameter specific to a driver of the vehicle, and wherein upon recognition of the driver by the vehicle, the parameter is used in generating the sound-influencing signal.

7. The method according to claim 1, wherein the parameter has information about at least one of a geographical location of the vehicle and the time, so that the sound-influencing signal is generated as a function of at least one of the geographical location of the vehicle and the time.

8. The method according to claim 1, wherein the parameter includes information about a setting of one component of the vehicle, so that the sound-influencing signal is generated as a function of the setting of the component.

9. The method according to claim 8, wherein the component is a variable convertible top of the vehicle.

10. A sound-influencing device for influencing sound in an aggregate in a periphery of an internal combustion engine of a vehicle, comprising:
means for generating a sound-influencing signal as a function of a detected sound emission of the aggregate and a parameter that is independent of an operating point of the internal combustion engine; and
means for injecting the sound-influencing signal into the aggregate.

11. A computer-readable medium containing a computer program which when executed by a processor performs the following method for influencing sound in an aggregate in a periphery of an internal combustion engine of a vehicle:
generating a sound-influencing signal as a function of a detected sound emission of the aggregate and a parameter that is independent of an operating point of the internal combustion engine; and
injecting the sound-influencing signal into the aggregate.
